(19) United States
(12) Patent Application Publication
(10) Pub. No.: US 2015/0310433 A1
(43) Pub. Date: Oct. 29, 2015

(54) INTERNET CURRENCY AND A SYSTEM AND METHOD FOR ONLINE INTERNET CURRENCY TRANSACTIONS

(71) Applicant: Aslam Gani, Mylapore (IN)

(72) Inventor: Aslam Gani, Mylapore (IN)

(21) Appl. No.: 14/262,227

(22) Filed: Apr. 25, 2014

(51) Int. Cl. G06Q 20/40; G06Q 40/00; G06Q 30/02

(52) U.S. Cl. CPC G06Q 20/40; G06Q 30/0226; G06Q 40/06; G06Q 40/10; G06Q 40/02

(57) ABSTRACT

The various embodiments herein provide a system and a method for online internet currency transactions. The system and method includes a Central Internet Bank (CIB) created at World Wide Web (WWW) level. A network is provided in electronic communication with the CIB. A plurality of account holding entities are registered with the CIB. A plurality of online service providers is associated with each account holding entity. An Internet Credit Rating Agency (ICRA) is associated with the account holding entities. The CIB issues and holds Binary Credit Bits (BCB) of the account holding entities and authenticates online transactions between at least two account holding entities in real time and authenticates online transactions between at least one account holding entity and at least one online service provider in real time.

### CROSS REFERENCE TO RELATED APPLICATIONS

This application claims priority under 35 U.S.C. 119(e) to U.S. Provisional Patent Application with Ser. No. 61/377,101, filed Aug. 26, 2010, the contents of which are incorporated entirely herein. This application is a continuation of U.S. patent application with Ser. No. 12/965,936, filed on Dec. 13, 2010, the contents of which are hereby incorporated entirely. The afore-mentioned patent applications are hereby incorporated by reference by its entirety.

### BACKGROUND

1. Technical field

The embodiments herein generally relate to a system and method for a negotiable instrument used for web based purchases and settlements. The embodiments herein more particularly relate to an internet currency for web based transactions for data. The embodiments herein more particularly relates to a system and method for data transactions using internet currency.

2. Description of the Related Art

Often, the electronic payment transactions become increasingly important. Accordingly tremendous efforts are made for developing a suitable system and method for carrying out the electronic payment transactions. Currently a consumer wishing to make a purchase over the Internet utilizes his or her personal credit card. Secured servers utilized by online service providers accept credit cards and provide protection, via various encryption processes, for the interception of credit card information by third party “hackers”. However, even if no “hacking” takes place, the online service provider ultimately has the consumer's credit card number.

At present, there is no independent currency in the internet with the value of the holding related to the transactions in www world. In the currently existing schemes, there is no independent central bank to issue the currency or create a currency reserve, such as real time currency based on the value of data transactions happening on the network. Moreover there is no system to estimate the demand for data transaction which is the future for internet world. Further there has been no control over any data transactions in the existing Internet. Still further, there is no responsibility for the uploading and the downloading of data from one country to another country and there is no priority of data transfer in the network for sites as there is no way of identification of the specific sites on the internet highway.

At present, there is no control over any data transactions in the existing Internet. The data can be downloaded or uploaded by any country or company in the Internet. No system is available for a priority data transfer or information in the net for any special sites as there is no way for the identification on the Internet highway. There is no common secured internet site to hold personal electronic data and also exchange data automatically with any other entity, as all vital personal data is held in various sites and various unauthorized repositories held by internet communities etc. Also there is no bank to hedge other real currencies and to create new currency capital funding based on a data transaction and policing of the internet highway. It is not possible to control and prioritize a cheap upload over a valuable upload or a site while searching over any search engine except by a payment made to the search engine companies.

Hence, there is a need for an efficient system and method for providing real time internet currency transactions between account holding entities and online service providers in form of Binary Credit Bits (BCB's) through a central bank called Central Internet Bank (CIB). Also there exists a need to provide the CIB to issue the currency or create a currency reserve, such as real time currency based on the value of data transactions happening on the network. Further there exists a need to provide prioritized data transfer in the network among the account holding entities and the online service providers for identified specific sites on internet highways.

The abovementioned shortcomings, disadvantages and problems are addressed herein and which will be understood by reading and studying the following specification.

### OBJECTS OF THE EMBODIMENTS

The primary object of the embodiments herein is to provide a system and method for real time internet currency transactions between the account holding entities and online service providers in the form of Binary Credit Bits (BCB's) through a central bank called Central Internet Bank (CIB).

Another object of the embodiments herein is to develop a CIB to issue the currency or create a currency reserve, such as real time currency, based on the value of data transactions executed on the network.

Yet another object of the embodiments herein is to develop a system and method to provide a prioritized data transfer in the network among the account holding entities and the online service providers for the identified specific sites on internet highways.

Yet another object of the embodiments herein is to develop a system and method to award, transact and hold BCBs to any individual or group or company account holding entities.

Yet another object of the embodiments herein is to develop a system and method to create accounts like real time banking accounts, to provide different formats of BCB trading and transactions, and to maintain security and authenticity of the account holding entities.

Yet another object of the embodiments herein is to develop a system and method to award loyalty programs to users or account holding entities of various e-communities based on the data uploaded or downloaded by the account holding entities.

Yet another object of the embodiments herein is to develop a system and method to charge various free internet applications based on data packets downloaded in various region through broadband and to make payment using BCB bought from capital banking of the CIB.

Yet another object of the embodiments herein is to develop a system and method to allocate BCB along with currency capital to all businesses using internet services irrespective of application size, based on packets of data transacted by online internet service providers.

Yet another object of the embodiments herein is to develop a system and method to open CIB at individual countries for providing Ibanking policy depending on individual account holding entities or a company registered with the CIB.

Yet another object of the present invention is to develop a system and method to create a unique interface with all web based applications to initiate recording, saving and encoding the data directly to the account of the account holding entities and to a buffer.

Yet another object of the embodiments herein is to develop a system and method to create accounts for account holding entities and companies for saving vital information associated with the account holding entities and the companies in a structured format with a nominal BCB fee using a unique Human interface identity number (UHII).

Yet another object of the present invention is to develop a system and method to create accounts for account holding entities based on the classification of various data such as data, audio and video formats.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide system and method for online internet currency transactions between account holding entities and online service providers. Examples of the account holding entities and the online service providers include but are not limited to Government organizations, bank s, educational institutions, individuals, legal departments, multimedia stores, various Internet communities, various internet based merchandize, hotels, trading houses, individual website owners, email service providers website developers, and Internet based sales and purchases of airline tickets.

According to one embodiment herein, a system is provided for online internet currency transactions. The system comprises a Central Internet Bank (CIB) portal at World Wide Web (WWW) level. A plurality of account holding entities is connected to a server in the CIB portal through a communication network. The plurality of account holding entities is registered with the CIB using a user interface and a computing device. A plurality of online service providers is associated or communicatively connected with each account holding entity in the plurality of the account holding entities through the respective computing devices and server device. An Internet Credit Rating Agency (ICRA) is communicatively connected to the plurality of the account holding entities.

According to one embodiment herein a system is provided for online internet currency transactions, the system comprising: a Central Internet Bank (CIB) portal at World Wide Web (WWW) level; a network in electronic communication with the CIB; a plurality of account holding entities registered with the CIB; a plurality of online service providers associated with each account holding entity in the plurality of the account holding entities; and an Internet Credit Rating Agency (ICRA) associated with the plurality of the account holding entities; Wherein the CIB issues Binary Credit Bits (BCB) to the plurality of account holding entities for making a payment for a data transaction executed between two of the plurality of account holding entities or between one of the plurality of the account holding entities and a service provider and wherein the CIB repurchases the BCB issued to anyone of the plurality of the account holding entities and wherein the CIB holds Binary Credit Bits (BCB) of the plurality of the account holding entities to authenticate online transactions between at least two of the plurality of the account holding entities in real time and to authenticate online transactions between at least one of the plurality of the account holding entities and at least one of the online service provider in real time.

According to one embodiment herein, the CIB issues Binary Credit Bits (BCB) to the plurality of account holding entities for making a payment for a data transaction executed between two of the plurality of account holding entities or between one of the plurality of the account holding entities and a service provider. The CIB repurchases the BCB issued to anyone of the plurality of the account holding entities. The CIB holds Binary Credit Bits (BCB) of the plurality of the account holding entities to authenticate online transactions between at least two of the plurality of the account holding entities in real time and to authenticate online transactions between at least one of the plurality of the account holding entities and at least one of the online service provider in real time.

According to one embodiment herein, the network includes a Local Area Network (LAN), a Wireless Local Area Network (WLAN), a Wide Area Network (WAN), internet, a Small Area Network (SAN) and a Bluetooth.

According to one embodiment herein, the CIB stores a data or vital information associated with the plurality of account holding entities in a standardized format.

According to one embodiment herein, the ICRA evaluates and provides a credit rating to the plurality of account entities based on a size of the data stored by the plurality of account holding entities in the CIB.

According to one embodiment herein, the system further comprises a plurality of Associate Central Internet Bank (ACIB) branches affiliated to the CIB and wherein the plurality of Associate Central Internet Bank (ACIB) branches are positioned respectively at a plurality of individual countries.

According to one embodiment herein, a method is provided for executing online internet currency transactions. According to one embodiment herein, a non-transitory computer-readable medium is provided to store the instructions that are executable by one or more processors or computing devices or server devices to perform a method for online internet currency transactions, the method comprising the following steps. A Central Internet Bank (CIB) portal with a server device is created at World Wide Web (WWW) level. A plurality of account holding entities is communicatively connected to a server device at the CIB portal through a network and a computing device. The computing device is selected from a group consisting of a personal computing device, laptop computer, mobile communication device, scanner device, copier device, a camera device, and a video camera device. A plurality of account holding entities is registered to the CIB using a user interface and the computing device. A CIB account is created for each of the plurality of account holding entities by the server device. A Unique Human Interface Identity (UHII) number is provided to each of plurality of account holding entities by the CIB server device. The Binary Credit Bits (BCB) is issued to each of the plurality of the account holding entities by the server device on receiving a payment from the plurality of the account holding entities. The BCB associated with each of the plurality of the account holding entities in the CIB is held or stored at a repository or a storage data base. A capital market exchange is created by the CIB with an authority to issue the BCB to each of the plurality of the account holding entities using the server device. Each of the plurality of the account holding entities is awarded with loyalty programs to be used within a specified duration of time for using plurality of e-communities by the server device.

A vital information received from the plurality of the account holding entities is recorded by the server device and an interface is created by the CIB for saving the recorded vital information by the server device directly into the UHII account number associated with each of the plurality of the account holding entities. The BCB issued to the plurality of the account holding entities is used to make payment for a data transaction executed between two of the plurality of account holding entities or between one of the plurality of the account holding entities and one online service provider;

The BCB is authenticated by the CIB during online transactions between at least two of the plurality of the account holding entities in real time using the server. The BCBs are authenticated the by the CIB during online transactions between at least one of the plurality of the account holding entities and one online service providers in real time using the server. The BCB is any one of a currency and a promissory note associated with each of the account holding entities for providing online transactions between at least two of the plurality of the account holding entities in real time and between at least one of the plurality of the account holding entities and one online service providers in real time;

A plurality of the e-communities is charged by the CIB in terms of BCB units based on data packets downloaded in respective regions through a plurality of broadband services using the server and a data tax is charged by a owner of a website in one country to one of the plurality of the account holding entities in another country based on number of recipients of the plurality of the account holding entities and size of data transacted by the plurality of the account holding entities using a computing device.

According to one embodiment herein, the step of creating of the CIB account comprises

Identifying a plurality of selected account holding entities using the UHII by the server device, pledging an amount in fixed deposit in terms of BCBs in the CIB by the plurality of the account holding entities using the computing device, providing internet highway patrol to the plurality of the account holding entities by the server device and accessing vital information associated with each of the plurality of the account holding entities by the server device.

According to one embodiment herein, the step of providing the UHII number comprises storing vital information associated with each of the plurality of the account holding entities in the CIB by the server device, securing the vital information by the CIB during online operations carried out by each of the plurality of the account holding entities using the server device, paying service charges in terms of BCBs by each of the plurality of the account holding entities for additional storage of the vital information associated with each of the plurality of the account holding entities using the computing device, and providing access to the vital information associated with one of the plurality of the account holding entities to another one of the plurality of the account holding entities using the server device.

According to one embodiment herein, the step of providing access to the vital information further comprises requesting the CIB for vital information associated with a third party account holding entity by one of the plurality of the account holding entities using a computing device, reporting the vital information associated with the third party account holding entities to the requested one of the plurality of the account holding entities using the computing device and collecting the service charges in terms of the BCBs by the CIB for reporting the vital information associated with the third party account holding entities to the requested one of the plurality of the account holding entities using the server device.

According to one embodiment herein, the method further comprises charging a plurality of the e-communities by the CIB in terms of BCB units using the server device based on data packets downloaded in respective regions through a plurality of broadband services.

According to one embodiment herein, the method further comprises purchasing the flagged data packets by the plurality of the account holding entities using the computing device, issuing the flagged data packets to the plurality of the account holding entities by the CIB using the server device, and transacting vital information by the plurality of the account holding entities over a prioritized internet highway patrol using the computing device.

According to one embodiment herein, the method further comprises creating a data bond by the CIB using the server device, issuing the data bond to a plurality of investors and shareholders associated with the CIB using the server device, and injecting a capital into the CIB by the plurality of investors and shareholders using the computing device.

According to one embodiment herein the system for online internet currency transaction includes a Central Internet Bank (CIB) portal with a server created at World Wide Web (WWW) level. A plurality of accounting holding entities is communicatively connected to the CIB portal through a network. A plurality of account holding entities are registered with the CIB portal through a user interface using the computing device and wherein the computing device is a laptop or computer or a mobile communication device. Further, a plurality of online service providers is associated with each of the account holding entities. An Internet Credit Rating Agency (ICRA) is associated with the plurality of account holding entities. The CIB holds Binary Credit Bits (BCB) of the plurality of account holding entities and authenticates online transactions between at least two account holding entities in real time. The CIB authenticates online transactions between at least one of the account holding entities and at least one of the online service provider in real time. Examples of the network include but are not limited to a Local Area Network (LAN), a Wireless Local Area Network (WLAN), a Wide Area Network (WAN), internet, a Small Area Network (SAN) and a Bluetooth.

The CIB stores vital information associated with the plurality of account holding entities in a CIB standardized format. Examples of the vital information associated with the account holding entities include but are not limited to a profile, individual biometric and forensic details, medical records, vital genetic records, inpatient and outpatient lab records, doctors prescriptions, government records, academic records, professional resume, trading and purchase records, Google search results, face book messages, birth certificate, stem cell details, birth related medical reports, banking transaction reports, life time pictures and photographic directory, educational history, job details, references and recommendation details, Professional experience related history and real time transaction saved in a structured format, offspring and spouse details, vehicle number plate details and history of transaction with licenses and details of accidents.

The ICRA evaluates and provides credit rating to the plurality of account entities based on the size of the data stored by the plurality of account holding entities in the CIB. The system also includes plurality of Associate Central Internet Bank (ACIB) branches affiliated to the CIB which are present in plurality of individual countries.

According to one embodiment herein, the method for online internet currency involves creating a Central Internet Bank (CIB) portal with a server at World Wide Web (WWW) level. A plurality account holding entities is registered with the server at the CIB portal through a user interface and a computing device. The user interface is provided at the server. The CIB server creates a CIB account for each of the account holding entities. Further, a Unique Human Interface Identity (UHII) account number is provided to each of the account holding entities by the CIB server. Binary Credit Bits (BCB) is purchased by the account holding entities through the computing device. The post purchasing of the BCB issued by the CIB to the account holding entities is performed by the online service providers. The CIB holds the BCB associated with each of the account holding entities in a repository or storage database. Furthermore, a capital market exchange is created by the CIB server with an authority to issue the BCB to each of the account holding entities. The BCB is authenticated by the CIB server during online transactions between at least two account holding entities in real time or during online transactions between at least one of the account holding entities and at least one of the online service providers in real time.

The BCB is one of a currency or a promissory note associated with each of the account holding entities for providing online transactions between at least two of the account holding entities in real time or between at least one of the account holding entities and at least one of the online service providers in real time through the computing devices. Once the CIB account is created, the plurality of selected account holding entities are identified. Further the selected account holding entities pledge an amount in fixed deposit in terms of BCBs in the CIB. An internet highway patrol is provided to the selected account holding entities, for accessing vital information associated with plurality of the selected account holding entities from the CIB. Examples of the selected account holding entities include, but are not limited to a prioritized account holding entities, commercial account holding entities and prestigious account holding entities registered with the CIB.

Once the UHII account number is provided, the vital information associated with each of the account holding entities are stored in the CIB by the account holding entities. Further the stored vital information is secured by the CIB during online operations carried out by each of the account holding entities. A service charge is levied in terms of BCBs by the CIB for every online operation carried out by each of the account holding entities or for additional storage of the vital information by each of the account holding entities. The CIB also provides access to the vital information associated with plurality of the account holding entities to third party account holding entities upon paying the service charges by each of the account holding entities.

Providing access to the vital information further includes requesting the CIB for vital information associated with third party account holding entities by plurality of the account holding entities. Further the vital information associated with the third party account holding entities are reported to the requested account holding entities. Furthermore service charges are collected in terms of the BCBs by the CIB for reporting the vital information associated with the third party account holding entities to the requested account holding entities.

The method also includes awarding loyalty programs to each of the account holding entities for using plurality of e-communities. The awarded loyalty programs are to be used within a specified duration of time. Examples of the e-communicates include but are not limited to face book, twitter, yahoo, Google, and Amazon. The e-communities are charged in terms of BCB units based on data packets downloaded in respective regions through plurality of broadband services. Third party account holding entities of another country are charged in terms of data tax by owner of a website related to a particular country based on number of recipients of the account holding entities and size of data that is transacted by the third party account holding entities.

The method also includes providing an option for purchasing flagged data packets by the account holding entities. Further the flagged data packets are issued to the account holding entities by the CIB and the vital information is transacted by the account holding entities over prioritized internet highway. The method also involves creating a data bond by the CIB. Once the data bond is created, the data bond is issued to plurality of investors and shareholders associated with the CIB for injecting capital into the CIB. Furthermore, the method involves providing an option for recording vital information from plurality of the account holding entities directly by creating an interface with the CIB. The recorded vital information is saved into the UHI account number associated with each of the account holding entities.

Thus the various embodiments herein provide system and method for online internet currency transactions. The CIB which is the holder of BCB is entitled to transact equivalent size of data transaction. The BCB is fully convertible to real time currencies as it has been capitalized initially. The BCB is traded in any currency exchange with all leading stock exchanges of the world. The CIB provides absolute value estimation of BCB based on the world's dependence on data transactions over the network. The CIB stores vital information associated with account holding entities in a structured format right from the birth to death. The system also provides a storage for the vital information in a structured manner providing a multilayer security for various levels of data transaction between the account holding entities.

The system permits an automatic exchange and access of data to new account holding entities at low level security. Also the system provides for an exchange and storage of data or information related to academic reports, performances and certificates from various schools, universities and educational institutions to students. Further, the system enables an exchange and storage of data or information related to medical data history since birth from hospitals through a high level data security. It also permits exchange or storage of data or information related to monetary transactions, fixed deposit documents, statements of the accounts on real time from banks through a high level data security. The system also allows an exchange and storage of data on all card based purchases from the account holding entities. Thus the system enables the Internet service providers to charge not only the account holding entities but also the website owners based on data transacted. The system also provides an option for the purchase of any product on Internet using BCB by marking all products and merchandize with an equivalent tag price in BCB units.

The examples of various application areas on which the various embodiments herein are performed includes but are not limited to all conceivable areas in which an existing real time currencies exists and transactions are made over internet, government organizations, banks, institution, trading houses, stock exchanges, Internet service providers, broadband infrastructure developers, satellite operators, companies using TV and audio transmissions and companies using data with internet driven payments. Further the application areas include various Internet communities, various internet based merchandize, hotels, trading houses, individual website owners, email service providers, website developers and Internet based sales and purchases of airline tickets.

Moreover the transactions using BCB helps in buying or selling data packages from online internet service providers, TV live streaming, audio, music material and data packages of internet telephone through a network or internet and data related transaction between broadband service suppliers through internet. The BCB can be repurchased by CIB. The BCB can be bought and sold at any moment by the account holding entities.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating transaction of Binary Credit Bits (BCB) between the account holding entities and the online service providers according to one embodiment herein.

FIG. 2 is a schematic block diagram illustrating Central Internet Bank (CIB) and storage of BCB in the CIB according to one embodiment herein.

FIG. 3 is a schematic block diagram illustrating an Associate Central Internet Bank (ACIB) according to one embodiment herein.

FIG. 4 is a block diagram illustrating vital information exchange between two account holding entities according to one embodiment herein.

FIG. 5 is a block diagram illustrating a transfer and storage of vital information from account holding entity to the Associate Central Internet Bank (ACIB) according to one embodiment herein.

FIG. 6 is a schematic block diagram illustrating consumer's space in real world and account holding entities space in internet world according to one embodiment herein.

FIG. 7 is a block diagram illustrating a transaction between an account holding entity and e-community according to one embodiment herein.

FIG. 8 is a block diagram illustrating an auto transfer of vital information from hand held devices associated with account holding entity into the CIB according to one embodiment herein.

FIG. 9 is a block diagram illustrating internet highway patrols for prioritized access of vital information between account holding entities according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method for online internet currency transactions between the account holding entities and the online service providers. Examples of the account holding entities and the online service providers include but are not limited to Government organizations, bank s, educational institutions, individuals, legal departments, multimedia stores, various Internet communities, various internet based merchandize, hotels, trading houses, individual website owners, email service providers website developers and Internet based sales and purchases of airline tickets.

According to one embodiment herein, the system for online internet currency transaction includes a Central Internet Bank (CIB) created at World Wide Web (WWW) level. A network is provided in electronic communication with the CIB. A plurality of account holding entities is registered with the CIB. Further, a plurality of online service providers is associated with each of the account holding entities. An Internet Credit Rating Agency (ICRA) is associated with the plurality of account holding entities. The CIB holds Binary Credit Bits (BCB) of the plurality of account holding entities and authenticates the online transactions between at least two account holding entities in real time or authenticates the online transactions between at least one of the account holding entity and at least one of the online service providers in real time. Examples of the network include but are not limited to a Local Area Network (LAN), a Wireless Local Area Network (WLAN), a Wide Area Network (WAN), internet, a Small Area Network (SAN) and a Bluetooth.

The CIB stores vital information associated with the plurality of account holding entities in a standardized format. Examples of the vital information associated with the account holding entities include but are not limited to a profile, individual biometric and forensic details, medical records, vital genetic records, inpatient and outpatient lab records, doctors prescriptions, government records, academic records, professional resume, trading and purchase records, Google search results, face book messages, birth certificate, stem cell details, birth related medical reports, banking transaction reports, life time pictures and photographic directory, educational history, job, references and recommendation details, Professional experience related history, real time transaction saved in a structured format, history of transaction, offspring and spouse details, vehicle number plate details, licenses and details of accidents.

The ICRA evaluates and provides credit rating to the plurality of account entities based on size of the data stored by the plurality of account holding entities in the CIB. The system also includes plurality of Associate Central Internet Bank (ACIB) branches affiliated to the CIB which are present in plurality of individual countries.

According to one embodiment herein, the method for online internet currency includes a Central Internet Bank (CIB) created at World Wide Web (WWW) level. A plurality account holding entities are registered with the CIB. The CIB creates a CIB account for each of the account holding entities. Further, an Unique Human Interface Identity (UHII) account number is provided to each of the account holding entities by the CIB. Binary Credit Bits (BCB) is purchased by the account holding entities. The CIB enables the post purchasing of the BCB issued to the account holding entities. The CIB holds the BCB associated with each of the account holding entities. Furthermore, a capital market is created by the CIB with an authority to issue the BCB to each of the account holding entities. The BCB is authenticated by the CIB during online transactions between at least two account holding entities in real time or during online transactions between at least one of the account holding entities and at least one of the online service providers in real time.

The BCB is one of a currency or a promissory note associated with each of the account holding entities for providing online transactions between at least two of the account holding entities in real time or between at least one of the account holding entities and at least one of the online service providers in real time. Once the CIB account is created, the plurality of selected account holding entities are identified. Further the selected account holding entities pledge an amount in fixed deposit in the CIB in terms of BCBs. An internet highway patrol is provided to the selected account holding entities for accessing vital information associated with plurality of the selected account holding entities from the CIB. Examples of the selected account holding entities include, but are not limited to a prioritized account holding entities, commercial account holding entities and prestigious account holding entities registered with the CIB.

Once the UHII account number is provided, the vital information associated with each of the account holding entities are stored in the CIB by the account holding entities. Further the stored vital information is secured by the CIB during online operations carried out by each of the account holding entities. A service charge is levied in terms of BCBs by the CIB for every online operations carried out or for additional storage of the vital information by each of the account holding entities. The CIB also provides an access to the vital information associated with plurality of the account holding entities to third party account holding entities upon paying the service charges by the third party account holding entities.

The method of providing access to the vital information further includes requesting the CIB for vital information associated with third party account holding entities by plurality of the account holding entities. Further the vital information associated with the third party account holding entities are reported to the requested account holding entities. Furthermore service charges are collected in terms of the BCBs by the CIB for reporting the vital information associated with the third party account holding entities to the requested account holding entities.

The method also includes awarding loyalty programs to be used within a specified duration of time, to each of the account holding entities for using plurality of e-communities. Examples of the e-communicates include but are not limited to face book, twitter, yahoo, Google, and Amazon. The e-communities are charged in terms of BCB units based on data packets downloaded in respective regions through plurality of broadband services. Third party account holding entities of another country are charged in terms of data tax by the owner of a website related to a particular country based on the number of recipients of the account holding entities and the size of data transacted by the third party account holding entities.

The method also provides an option for purchasing flagged data packets by the account holding entities. Further the flagged data packets are issued to the account holding entities by the CIB. The vital information is transacted by the account holding entities over prioritized internet highway patrols. The method involves creating a data bond by the CIB. Upon creation of the data bond, the data bond is issued to a plurality of investors and shareholders associated with the CIB for injecting capital into the CIB. Furthermore, the method involves recording vital information from plurality of the account holding entities directly by creating an interface. The recorded vital information is saved into the UHII account number associated with each of the account holding entities.

The various embodiments herein provide system and method for online internet currency transactions. The holder of BCB is entitled to transact equivalent size of data transaction. The BCB is fully convertible to real time currencies as it has been capitalized initially. The BCB is traded in any currency exchange with all leading stock exchanges of the world. The CIB provides absolute value estimation of BCB based on a dependence of the world on the data transactions over the network. The CIB stores vital information associated with account holding entities right from ones birth to death in a structured format. The system also provides a storage of the vital information in a structured manner thereby providing a multilayer security for various levels of data transaction between the account holding entities.

The system permits an automatic exchange and access of data to new account holding entities at low level security. Also the system provides for an exchange and storage of data or information related to academic reports, performances and certificates from various schools, universities and educational institutions to students. Further, the system enables an exchange and storage of data or information related to medical data history since birth from hospitals through a high level data security. It also permits exchange or storage of data or information related to monetary transactions, fixed deposit documents, statements of the accounts on real time from banks through a high level data security. The system also allows an exchange and storage of data on all card based purchases from the account holding entities. Thus the system enables the Internet service providers to charge not only the account holding entities but also the website owners based on data transacted. The system also provides an option for the purchase of any product on Internet using BCB by marking all products and merchandize with an equivalent tag price in BCB units.

The examples of various application areas on which the various embodiments herein are performed includes but are not limited to all conceivable areas in which an existing real time currencies exists and transactions are made over internet, government organizations, banks, institution, trading houses, stock exchanges, Internet service providers, broadband infrastructure developers, satellite operators, companies using TV and audio transmissions and companies using data with internet driven payments. Further the application areas include various Internet communities, various internet based merchandize, hotels, trading houses, individual website owners, email service providers, website developers and Internet based sales and purchases of airline tickets.

Moreover the transactions using BCB helps in buying or selling data packages from online internet service providers, TV live streaming, audio, music material and data packages of internet telephone through a network or internet and data related transaction between broadband service suppliers through internet. The BCB can be repurchased by CIB. The BCB can be bought and sold at any moment by the account holding entities.

According to one embodiment herein, a system is provided for online internet currency transactions. The system comprises a Central Internet Bank (CIB) portal at World Wide Web (WWW) level. A plurality of account holding entities is connected to a server in the CIB portal through a communication network. The plurality of account holding entities is registered with the CIB using a user interface and a computing device. A plurality of online service providers is associated or communicatively connected with each account holding entity in the plurality of the account holding entities through the respective computing devices and server device. An Internet Credit Rating Agency (ICRA) is communicatively connected to the plurality of the account holding entities.

According to one embodiment herein, the CIB issues Binary Credit Bits (BCB) to the plurality of account holding entities for making a payment for a data transaction executed between two of the plurality of account holding entities or between one of the plurality of the account holding entities and a service provider. The CIB repurchases the BCB issued to anyone of the plurality of the account holding entities. The CIB holds Binary Credit Bits (BCB) of the plurality of the account holding entities to authenticate online transactions between at least two of the plurality of the account holding entities in real time and to authenticate online transactions between at least one of the plurality of the account holding entities and at least one of the online service provider in real time.

According to one embodiment herein, the network includes a Local Area Network (LAN), a Wireless Local Area Network (WLAN), a Wide Area Network (WAN), internet, a Small Area Network (SAN) and a Bluetooth.

According to one embodiment herein, the CIB stores a data or vital information associated with the plurality of account holding entities in a standardized format.

According to one embodiment herein, the ICRA evaluates and provides a credit rating to the plurality of account entities based on a size of the data stored by the plurality of account holding entities in the CIB.

According to one embodiment herein, the system further comprises a plurality of Associate Central Internet Bank (ACIB) branches affiliated to the CIB and wherein the plurality of Associate Central Internet Bank (ACIB) branches are positioned respectively at a plurality of individual countries.

According to one embodiment herein, a method is provided for executing online internet currency transactions. According to one embodiment herein, a non-transitory computer-readable medium is provided to store the instructions that are executable by one or more processors or computing devices or server devices to perform a method for online internet currency transactions, the method comprising the following steps. A Central Internet Bank (CIB) portal with a server device is created at World Wide Web (WWW) level. A plurality of account holding entities is communicatively connected to a server device at the CIB portal through a network and a computing device. The computing device is selected from a group consisting of a personal computing device, laptop computer, mobile communication device, scanner device, copier device, a camera device, and a video camera device. A plurality of account holding entities is registered to the CIB using a user interface and the computing device. A CIB account is created for each of the plurality of account holding entities by the server device. A Unique Human Interface Identity (UHII) number is provided to each of plurality of account holding entities by the CIB server device. The Binary Credit Bits (BCB) is issued to each of the plurality of the account holding entities by the server device on receiving a payment from the plurality of the account holding entities. The BCB associated with each of the plurality of the account holding entities in the CIB is held or stored at a repository or a storage data base. A capital market exchange is created by the CIB with an authority to issue the BCB to each of the plurality of the account holding entities using the server device. Each of the plurality of the account holding entities is awarded with loyalty programs to be used within a specified duration of time for using plurality of e-communities by the server device.

A vital information received from the plurality of the account holding entities is recorded by the server device and an interface is created by the CIB for saving the recorded vital information by the server device directly into the UHII account number associated with each of the plurality of the account holding entities. The BCB issued to the plurality of the account holding entities is used to make payment for a data transaction executed between two of the plurality of account holding entities or between one of the plurality of the account holding entities and one online service provider;

The BCB is authenticated by the CIB during online transactions between at least two of the plurality of the account holding entities in real time using the server. The BCBs are authenticated the by the CIB during online transactions between at least one of the plurality of the account holding entities and one online service providers in real time using the server. The BCB is any one of a currency and a promissory note associated with each of the account holding entities for providing online transactions between at least two of the plurality of the account holding entities in real time and between at least one of the plurality of the account holding entities and one online service providers in real time;

A plurality of the e-communities is charged by the CIB in terms of BCB units based on data packets downloaded in respective regions through a plurality of broadband services using the server and a data tax is charged by a owner of a website in one country to one of the plurality of the account holding entities in another country based on number of recipients of the plurality of the account holding entities and size of data transacted by the plurality of the account holding entities using a computing device.

According to one embodiment herein, the step of creating of the CIB account comprises identifying a plurality of selected account holding entities using the UHII by the server device, pledging an amount in fixed deposit in terms of BCBs in the CIB by the plurality of the account holding entities using the computing device, providing internet highway patrol to the plurality of the account holding entities by the server device and accessing vital information associated with each of the plurality of the account holding entities by the server device.

According to one embodiment herein, the step of providing the UHII number comprises storing vital information associated with each of the plurality of the account holding entities in the CIB by the server device, securing the vital information by the CIB during online operations carried out by each of the plurality of the account holding entities using the server device, paying service charges in terms of BCBs by each of the plurality of the account holding entities for additional storage of the vital information associated with each of the plurality of the account holding entities using the computing device, and providing access to the vital information associated with one of the plurality of the account holding entities to another one of the plurality of the account holding entities using the server device.

According to one embodiment herein, the step of providing access to the vital information further comprises requesting the CIB for vital information associated with a third party account holding entity by one of the plurality of the account holding entities using a computing device, reporting the vital information associated with the third party account holding entities to the requested one of the plurality of the account holding entities using the computing device and collecting the service charges in terms of the BCBs by the CIB for reporting the vital information associated with the third party account holding entities to the requested one of the plurality of the account holding entities using the server device.

According to one embodiment herein, the method further comprises charging a plurality of the e-communities by the CIB in terms of BCB units using the server device based on data packets downloaded in respective regions through a plurality of broadband services.

According to one embodiment herein, the method further comprises purchasing the flagged data packets by the plurality of the account holding entities using the computing device, issuing the flagged data packets to the plurality of the account holding entities by the CIB using the server device, and transacting vital information by the plurality of the account holding entities over a prioritized internet highway patrol using the computing device.

According to one embodiment herein, the method further comprises creating a data bond by the CIB using the server device, issuing the data bond to a plurality of investors and shareholders associated with the CIB using the server device, and injecting a capital into the CIB by the plurality of investors and shareholders using the computing device.

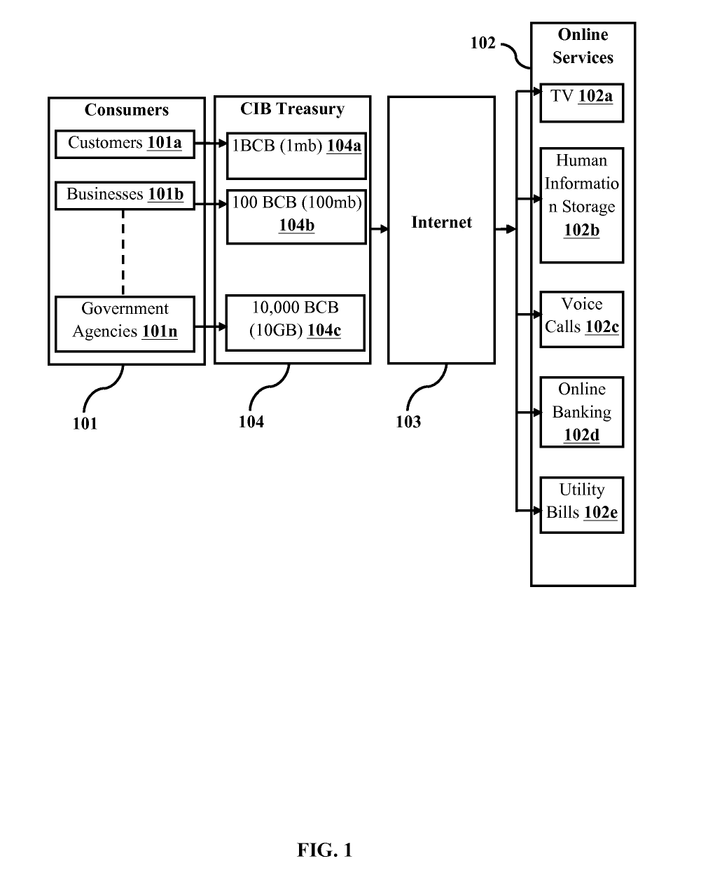

FIG. 1 is a block diagram illustrating a transaction of Binary Credit Bits (BCB) between the account holding entities and the online service providers according to one embodiment herein. With respect to FIG. 1 plurality of account holding entities 101 and plurality of online service providers 102 are in electronic communication with the network 103 through their respective computing devices. The online transactions between the account holding entities 101 and the online service providers happen in real time using Binary Credit Bits (BCBs) through the network 103. Examples of the network include but are not limited to a Local Area Network (LAN), a Wireless Local Area Network (WLAN), a Wide Area Network (WAN), internet, a Small Area Network (SAN) and a Bluetooth. The BCB units are stored in a CIB treasury or storage data base 104.

The Examples of the account holding entities and the online service providers include but are not limited to Government organizations, bank s, educational institutions, individuals, legal departments, multimedia stores, various Internet communities, various internet based merchandize, hotels, trading houses, individual website owners, email service providers, website developers and Internet based sales and purchases of airline tickets. The account holding entities includes and not limited to customers 101a, business entities 101b, government agencies 101n, etc. The examples of the online service providers include but not limited to television broadcast service providers 102a, human information storage 102b, voice call service providers 102c, banks 102d, and utility bills payment service providers 102e, etc.

The BCB is a currency and/or a promissory note which entitles and/or enriches the account holding entities to transact data or vital information associated with the account holding entities in terms of Mega Bytes (MB). 1 MB transaction of data is equivalent to one BCB unit 104a which is in turn equivalent to US $1 I one example. 100 BCB 104b and 10,000 BCB 104c are used to carry out data transactions equivalent to 1 MB, 100 MB and 10 GB respectively between the account holding entities 101 and the online service providers 102.

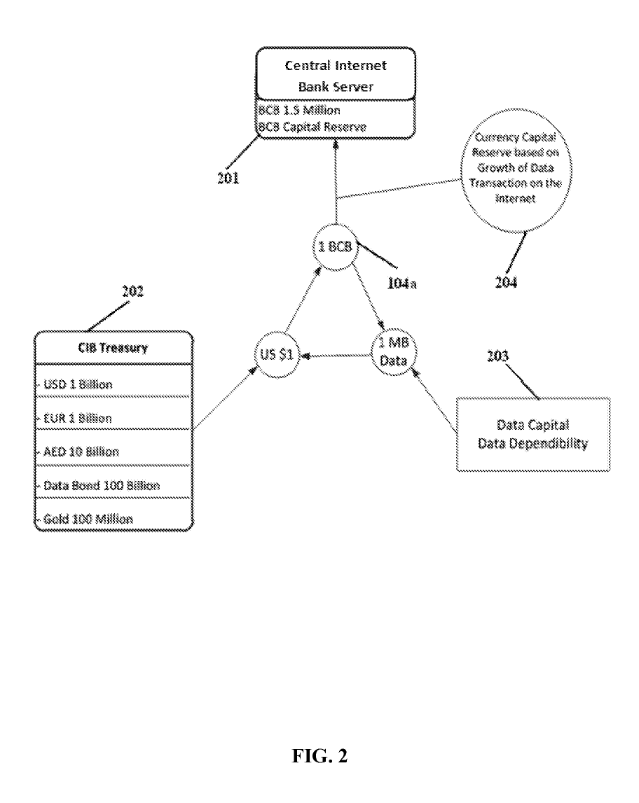

FIG. 2 is a block diagram illustrating a system comprising a Central Internet Bank (CIB) server and storage data base of BCB in the CIB according to one embodiment herein. With respect to the FIG. 2 the CIB is provided with a server device 201 and a CIB treasury 202 holding various currencies associated with various countries in terms of BCB units. The various currencies/assets in the CIB treasury 202 include but are not limited to US dollars, European Euros, Indian Rupees, gold and Data bonds. The data bonds are created by the CIB server 201 for injecting a currency capital 203 into the CIB by the plurality of investors and shareholders. The CIB performs the functions of a central bank which analyzes the required currency capital reserve holding based on the growth of the data transactions happening over the network 103 (as shown in FIG.1) for future.

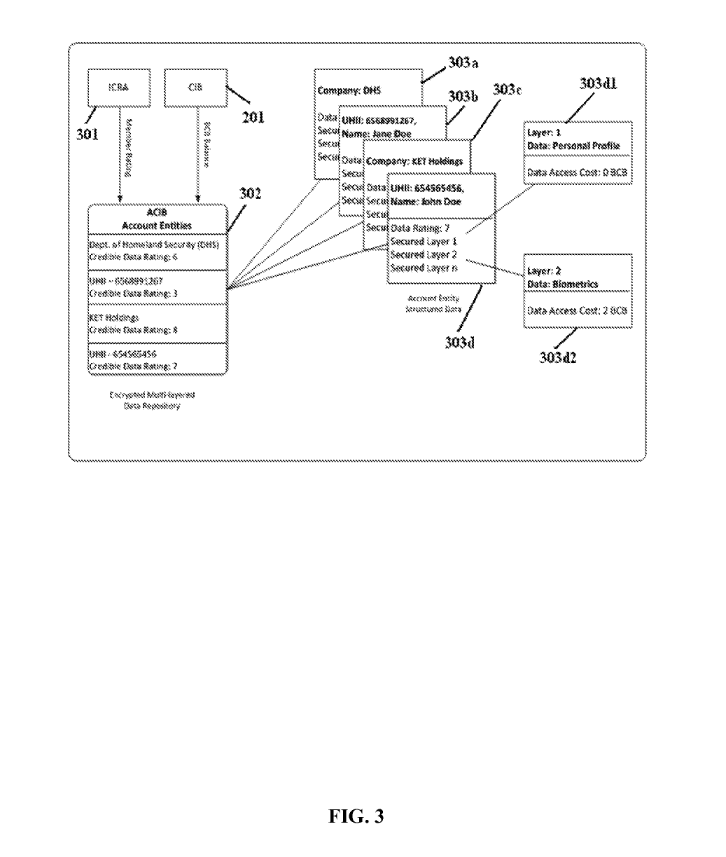

The BCB is a currency and/or a promissory note which entitles and/or enriches the account holding entities to transact data or vital information associated with the account holding entities in terms of Mega Bytes (MB). 1 MB transaction of data is equivalent to 1 BCB unit 104a which is in turn equivalent to US $1. A currency capital 204 and data capital 203 in the CIB 201 is generated based on the growth of data transactions happening over the network between the account holding entities and the online service providers. The CIB 201 holds fixed deposit of BCB units of all the account holding entities and provides highest of level of data security. Pluralities of bank branches known as Associate Central Internet Banks (ACIBs) (302 in FIG.3) are affiliated to the CIB 201 which is present in plurality of individual countries.

FIG. 3 is a block diagram illustrating an Associate Central Internet Bank (ACIB) system according to one embodiment herein. With respect to FIG. 3, the servers of the pluralities of bank branches known as Associate Central Internet Banks (ACIBs) 302 are affiliated to the CIB 201 which is present in plurality of individual countries. The ACIBs 302 holds only information of transactions of BCB units with highest level of authentication for transactions between the account holding entities. Further, all the transactions are also recorded in the CIB 201 and periodic or monthly bank statements are issued for providing transaction history to each of the account holding entities.

The plurality of account holding entities are registered with the CIB 201 through the user interface and the respective computing devices. The CIB server 201 creates a CIB account for each of the account holding entities. Further, a Unique Human Interface Identity (UHII) account number is provided to each of the account holding entities 303a, 303b, 303c, 303d by the CIB 201. Binary Credit Bits (BCB) are purchased by the account holding entities. The CIB 201 post purchases the BCB issued to the account holding entities. The CIB 201 holds the BCB associated with each of the account holding entities 303a-303d. Further, pluralities of account holding entities 303a-303b are also registered with the ACIB 302. The vital information associated with each of the account holding entities 303a-303d are stored in the UHII account number in the CIB 201. The vital information associated with each of the account holding entities 303a, 303b, 303c, 303d are stored in a structured format. Further the vital information is stored in terms of layers as layer-1 303d1, layer-2 303d2, layer-3 and layer-4 so on. As shown in FIG. 3, the layer-1 303d1 includes vital information associated with profile information of one of the account holding entity 303d having a UHII account number 654565456. The Layer-2 303d2 includes vital information associated with bioinformatics details of the account holding entity 303d having a UHII account number 654565456.

An Internet Credit Rating Agency (ICRA) 301 is associated with the plurality of account holding entities through the server in ICRA and the respective computing device of the plurality of account holding entities. The ICRA 301 evaluates and provides credit rating to the plurality of account entities based on size of the data stored by the plurality of account holding entities in the CIB 201. Wealth in the CIB 201 is determined purely based on deposited assets such as currency, gold and documents such as property and bonds. According to one embodiment, the ICRA 301 determines the deposited assets stored by each of the account holding entities in the ACIB 302 and provides credit rating to each of the account holding entities accordingly. Further, the deposited assets are convertible into BCB relevant to size of assets stored. The ICRA 301 also determines wealth of assets or data stored by commercial entities such a business houses providing wealth transparency of the business houses.

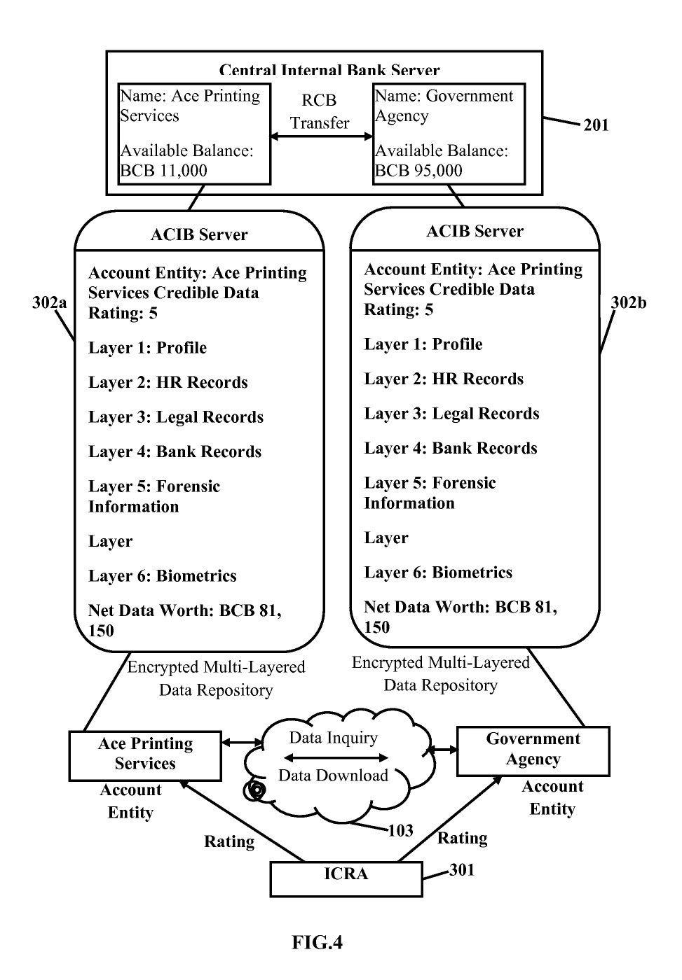

FIG. 4 is a block diagram of a system for vital information exchange between two account holding entities according to one embodiment herein. With respect to FIG. 4 a CIB server 201 is connected to the respective computing devices of two ACIB branches 302a and 302b. The computing device of an ace printing agent which is an account holding entity affiliated with the ACIB 302a and the computing device of a government agency which is another account holding entity affiliated with the ACIB 302b are communicatively connected to the CIB server 201 through the respective servers of the ACIB 301a, 301b. Both the account holding entities i.e. the ace printing agent and the government agency are registered with the CIB 201 and have purchased and deposited BCB units at the CIB 201. Both are provided with a unique UHII account number for storing vital information. The vital information associated with the ace printing agent and the government agency are encrypted and stored in a structured manner in the ACIB 302a and the ACIB 302b respectively. The online transactions between the ace printing agent and the government agency happen over the network 103 in terms of BCB units deposited at the CIB 201.

An Internet Credit Rating Agency (ICRA) 301 is associated with both the the plurality of account holding entities and the server of ICRA is communicatively connected to the computing devices of both the plurality of account holding entities. The server at ICRA 301 evaluates and provides credit rating to the ace printing agent and the government agency registered with the CIB 201 based on size of the data stored by the two account holding entities in the CIB 201. As shown in the block diagram, each of the ace printing agent and the government agency are provided with an Internet Credit Rating value of 5.

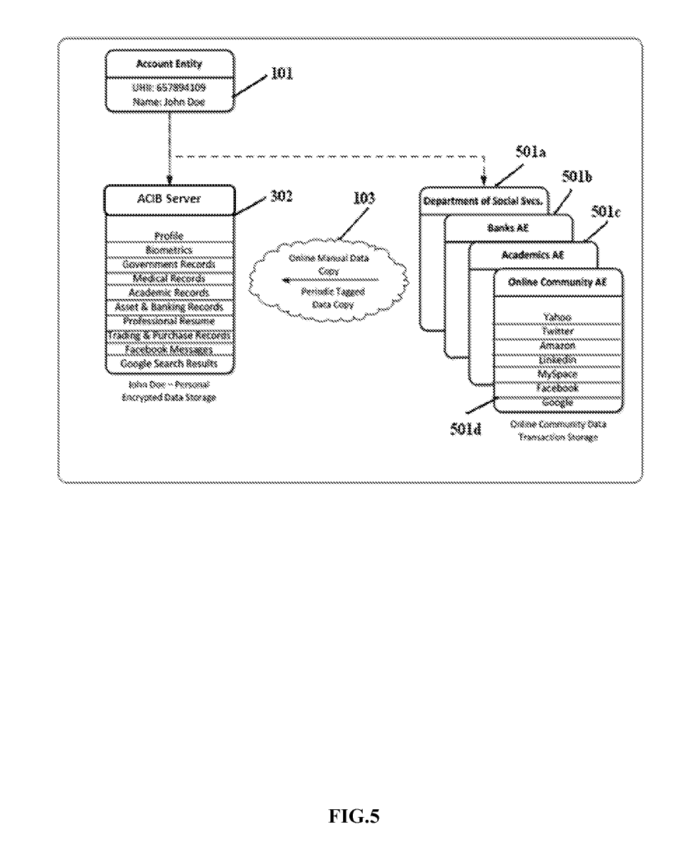

FIG. 5 is a block diagram of a system for transferring vital information from account holding entity to the Associate Central Internet Bank (ACIB) according to one embodiment herein. With respect to FIG. 5, an account holding entity 101 named John Doe is provided with a Unique Human Interface Identity (UHII) account number 657894109. The UHII account number enables John Doe for storing the vital information into ACIB 302 with which John Doe is registered with. The vital information transferred by the account holding entity over a network 103 is stored in the ACIB 302 account number 657894109. All the vital information such as profile, biometrics, government records, medical records, academic records, face book messages, professional resume etc are encrypted and stored in an ACIB 302 in standardized format. Further, the transactions related to e-community, for example., online transactions of department of social services 501a, Bank transactions 501b, Academic data related transactions 501c and online community transactions data 501d are also stored in an ACIB 302 standardized format.

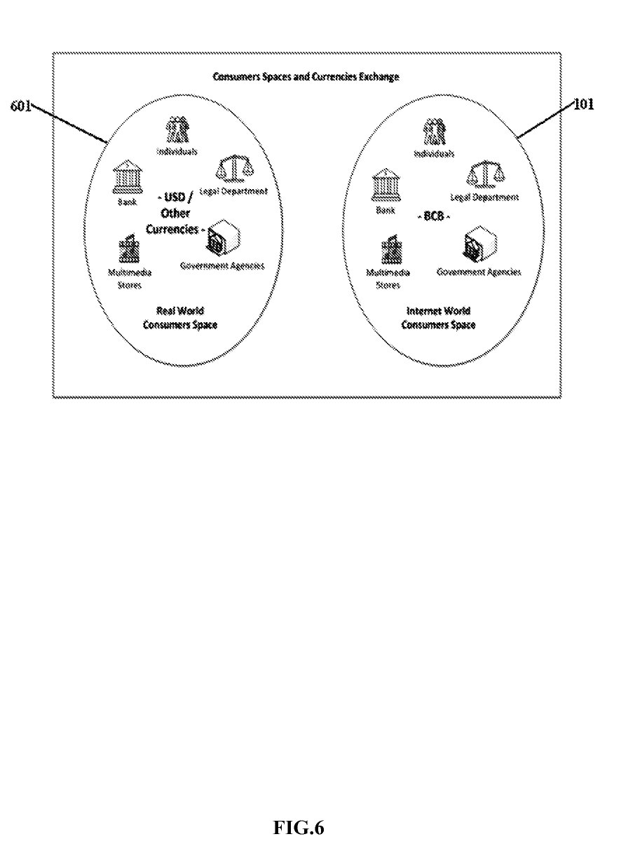

FIG. 6 is a block diagram illustrating a consumer space in real world and account holding entities space in internet according to one embodiment herein. With respect to FIG. 6, the consumers in the real world transact with various online and offline service providers in terms of usage of currency associated with individual countries. The account holding entities transact with various third party account holding entities and the plurality of online service providers through BCB units in real time over a network 103 (as shown in FIG. 1).

The Examples of the account holding entities and the online service providers include but are not limited to Government organizations, banks, educational institutions, individuals, legal departments, multimedia stores, various Internet communities, various internet based merchandize, hotels, trading houses, individual website owners, email service providers, website developers and Internet based sales and purchases of airline tickets. The BCB is a currency and/or a promissory note which entitles and/or enriches the account holding entities to transact data or vital information associated with the account holding entities in terms of Mega Bytes (MB). 1 MB transaction of data is equivalent to one BCB unit which is in turn equivalent to US $1. As indicated in the FIG. 1 BCB, 100 BCB and 10,000 BCB are equivalent to data transactions of 1 MB, 100 MB and 10 GB respectively between the account holding entities and the online service providers.

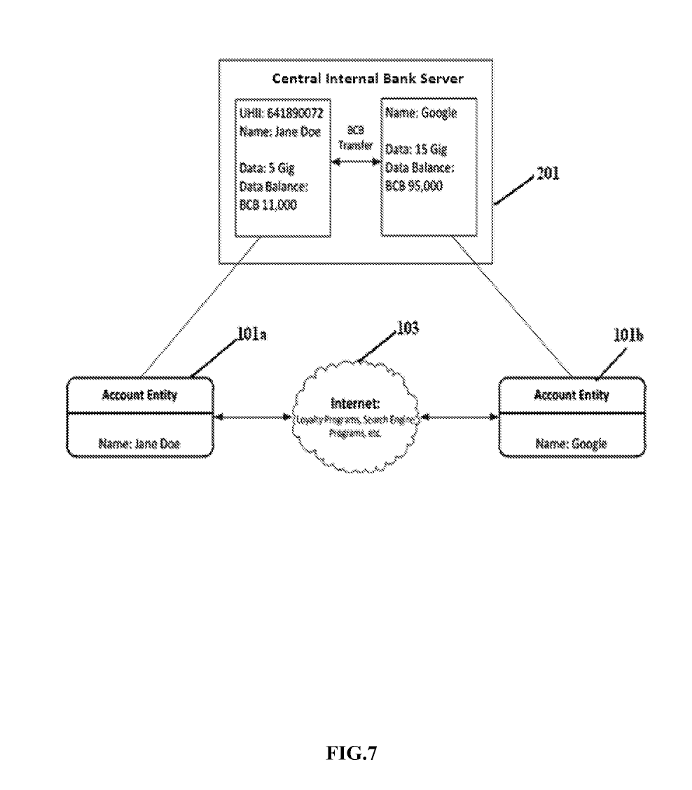

FIG. 7 is a block diagram of a system for transacting between an account holding entity and e-community according to one embodiment herein. With respect to FIG. 7 one of the account holding entity 101a, for example., an individual account holding entity say Jane doe., is associated with the CIB server 201. The individual account holding entity 101a transacts through BCB with an e-community account holding entity 101b say Google over a network 103 using the respective computing device provided in the individual account holding entity. Further, each of the account holding entity is awarded for using the e-community, with loyalty programs to be used within a specified duration of time.

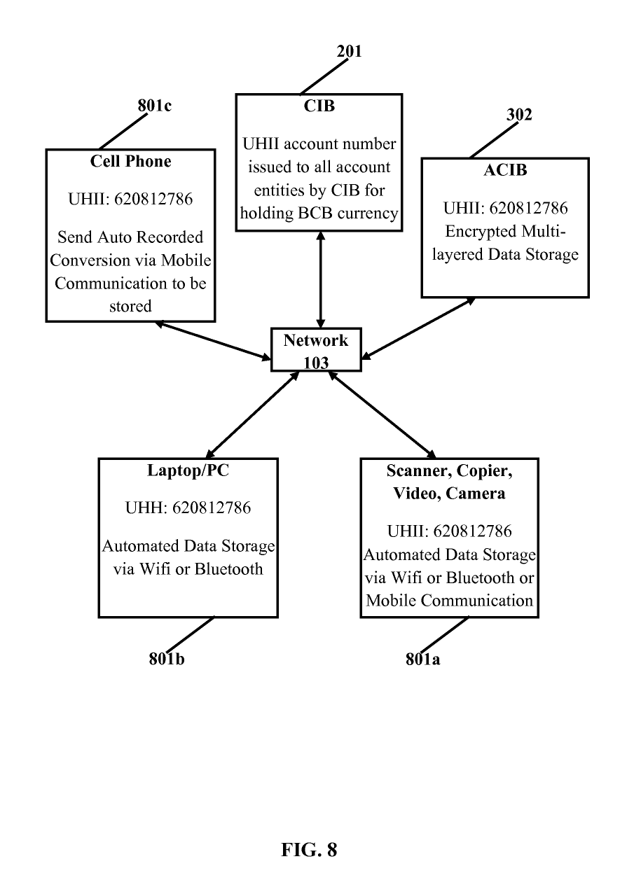

FIG. 8 is a block diagram of a system for an auto transfer of vital information from the hand held devices associated with each of account holding entity into the CIB according to one embodiment herein. With respect to FIG. 8, the vital information is automatically transferred from the CIB server 201 into the server at ACIB 301 over a network 103. A UHII account number associated with each of the account holding entities enables an automatic initiation of the recording of data or vital information associated with the account holding entities from the various hand held devices 801a-801c for a structured storage of the vital information in the ACIB 302 or CIB 201. The examples of the hand held devices include but are not limited to various electronic devices, mobile phones 801c, cameras, digitizers, scanners 801a, copier, mikes and personal computers 801b. The various hand held devices send the recorded vital information to the ACIB 302 or CIB 201 without a need for the transfer of the data manually, thereby reducing need to hold various vital information in various storage devices. The various hand held devices are provided with an interface for initiating automatic recording of the vital information.

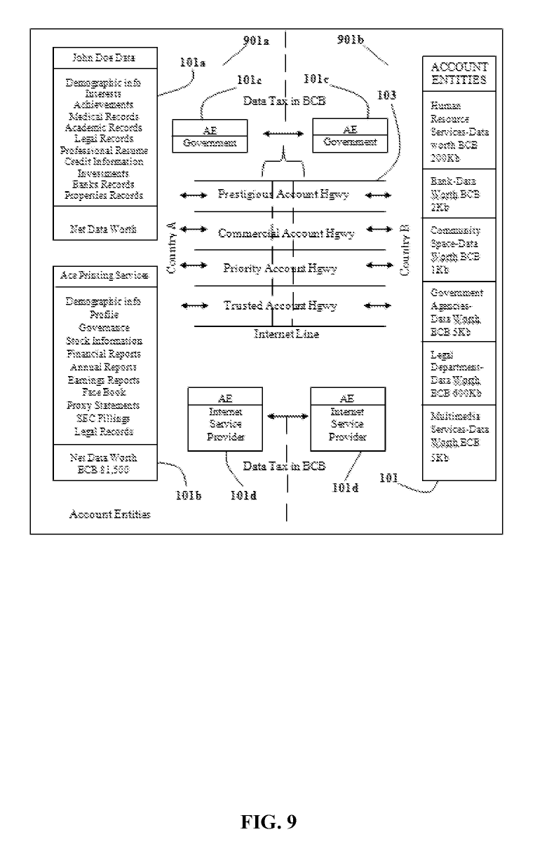

FIG. 9 is a block diagram illustrating internet highway patrols for prioritized access of vital information between account holding entities according to one embodiment herein. With respect to FIG. 9, the account holding entities 101a, 101b, 101c and 101d are situated in a country 901a. Further the account holding entities 101c1 and 101c2 and 101 are situated in a country 901b. The online transaction between the account holding entities 101a, 101b, 101c and 101d happens between countries 901a and 901b over a network 103. In order to transact a data over a prioritized highway patrol, all of the account holding entities are prior registered with the CIB for prioritized data transactions. The Flagged data packets are issued to the account holding entities by the CIB for transaction of the vital information among the countries 901a and 901b over prioritized internet highway patrols. As shown in FIG.9, the account holding entities transact through one or more of a prestigious account highway, Commercial account highway, a priority account highway and a trusted account highway.

The CIB and the ACIB are provided with the server devices while the account holding entities are provided with personal computing devices for communication and transactions disclosed in the methods of the various embodiments herein. Further the computing devices of the account holding entities and the server devices of the CIB and ACIB are communicatively connected through the network like internet to execute the transactions, the data transfer operations and the individual processes disclosed in the various methods of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A system for online internet currency transactions, the system comprising:
a Central Internet Bank (CIB) portal at World Wide Web (WWW) level;
a network in electronic communication with the CIB;
a plurality of account holding entities registered with the CIB;
a plurality of online service providers associated with each account holding entity in the plurality of the account holding entities; and
an Internet Credit Rating Agency (ICRA) associated with the plurality of the account holding entities;
Wherein the CIB issues Binary Credit Bits (BCB) to the plurality of account holding entities for making a payment for a data transaction executed between two of the plurality of account holding entities or between one of the plurality of the account holding entities and a service provider and wherein the CIB repurchases the BCB issued to anyone of the plurality of the account holding entities and wherein the CIB holds Binary Credit Bits (BCB) of the plurality of the account holding entities to authenticate online transactions between at least two of the plurality of the account holding entities in real time and to authenticate online transactions between at least one of the plurality of the account holding entities and at least one of the online service provider in real time.

2. The system of claim 1, wherein the network includes a Local Area Network (LAN), a Wireless Local Area Network (WLAN), a Wide Area Network (WAN), internet, a Small Area Network (SAN) and a Bluetooth.

3. The system of claim 1, wherein the CIB stores a data or vital information associated with the plurality of account holding entities in a standardized format.

4. The system of claim 1, wherein the ICRA evaluates and provides a credit rating to the plurality of account entities based on a size of the data stored by the plurality of account holding entities in the CIB.

5. The system of claim 1 further comprises a plurality of Associate Central Internet Bank (ACIB) branches affiliated to the CIB and wherein the plurality of Associate Central Internet Bank (ACIB) branches are positioned respectively at a plurality of individual countries.

6. A non-transitory computer-readable medium that stores instructions executable by one or more processors to perform a method for online internet currency transactions, the method comprising steps of:
creating a Central Internet Bank (CIB) portal with a server device at World Wide Web (WWW) level;
connecting a plurality of account holding entities to the CIB portal through a network and a computing device, and wherein the computing device is selected from a group consisting of a personal computing device, laptop computer, mobile communication device, scanner device, copier device, a camera device, and a video camera device;
registering a plurality of account holding entities to the CIB using a user interface and the computing device,
creating a CIB account for each of the plurality of account holding entities by the server device;
providing a Unique Human Interface Identity (UHII) number to each of plurality of account holding entities by the CIB server device;
issuing Binary Credit Bits (BCB) to each of the plurality of the account holding entities by the server device on receiving a payment from the plurality of the account holding entities;
holding the BCB associated with each of the plurality of the account holding entities in the CIB at a repository or a storage data base;
creating a capital market by the CIB with an authority to issue the BCB to each of the plurality of the account holding entities using the server device;
awarding each of the plurality of the account holding entities with loyalty programs to be used within a specified duration of time for using plurality of e-communities by the server device;
recording vital information received from the plurality of the account holding entities and creating an interface by the CIB for saving the recorded vital information by the server device directly into the UHII account number associated with each of the plurality of the account holding entities, and wherein the BCB issued to the plurality of the account holding entities is used to make payment for a data transaction executed between two of the plurality of account holding entities or between one of the plurality of the account holding entities and one online service provider;
authenticating the BCB by the CIB during online transactions between at least two of the plurality of the account holding entities in real time using the server;
authenticating the BCBs by the CIB during online transactions between at least one of the plurality of the account holding entities and one online service providers in real time using the server, and wherein the BCB is one of a currency and a promissory note associated with each of the account holding entities for providing online transactions between at least two of the plurality of the account holding entities in real time and between at least one of the plurality of the account holding entities and one online service providers in real time;
charging plurality of the e-communities by the CIB in terms of BCB units based on data packets downloaded in respective regions through a plurality of broadband services using the server; and
charging data tax by owner of a website in one country to one of the plurality of the account holding entities in another country based on number of recipients of the plurality of the account holding entities and size of data transacted by the plurality of the account holding entities using a computing device.

7. The method of claim 6, wherein step of creating of the CIB account comprises:
identifying plurality of selected account holding entities using the UHII by the server device;
pledging an amount in fixed deposit in terms of BCBs in the CIB by the plurality of the account holding entities using the computing device;
providing internet highway patrol to the plurality of the account holding entities by the server device; and
accessing vital information associated with each of the plurality of the account holding entities by the server device.

8. The method of claim 6, wherein step of providing the UHII number comprises:
storing vital information associated with each of the plurality of the account holding entities in the CIB by the server device;
securing the vital information by the CIB during online operations carried out by each of the plurality of the account holding entities using the server device;
paying service charges in terms of BCBs by each of the plurality of the account holding entities for additional storage of the vital information associated with each of the plurality of the account holding entities using the computing device; and
providing access to the vital information associated with one of the plurality of the account holding entities to another one of the plurality of the account holding entities using the server device.

9. The method of claim 6, wherein step of providing access to the vital information further comprises:
requesting the CIB for vital information associated with a third party account holding entity by one of the plurality of the account holding entities using a computing device;
reporting the vital information associated with the third party account holding entities to the requested one of the plurality of the account holding entities using the computing device; and
collecting service charges in terms of the BCBs by the CIB for reporting the vital information associated with the third party account holding entities to the requested one of the plurality of the account holding entities using the server device.

10. The method of claim 6 further comprises charging plurality of the e-communities by the CIB in terms of BCB units using the server device based on data packets downloaded in respective regions through a plurality of broadband services.

11. The method of claim 6 further comprises:
purchasing of flagged data packets by the plurality of the account holding entities using the computing device;
issuing the flagged data packets to the plurality of the account holding entities by the CIB using the server device; and
transacting vital information by the plurality of the account holding entities over a prioritized internet highway patrol using the computing device.

12. The method of claim 6 further comprises:
creating a data bond by the CIB using the server device;
issuing the data bond to a plurality of investors and shareholders associated with the CIB using the server device; and
injecting a capital into the CIB by the plurality of investors and shareholders using the computing device.
